(19) United States
(12) Patent Application Publication
(10) Pub. No.: US 2014/0041011 A1
(43) Pub. Date: Feb. 6, 2014

(54) METHOD AND DEVICE FOR CONTROL COMMUNICATION BETWEEN COUPLED TRAIN COMPONENTS

(71) Applicants: Ralf Beyer, Moerendorf (DE); Rainer Falk, Poing (DE)

(72) Inventors: Ralf Beyer, Moerendorf (DE); Rainer Falk, Poing (DE)

(73) Assignee: Siemens Aktiengesellschaft, Muenchen (DE)

(21) Appl. No.: 14/112,598

(22) PCT Filed: Apr. 10, 2012
(86) PCT No.: PCT/EP2012/056443

§ 371 Date: Oct. 18, 2013

(30) Foreign Application Priority Data
Apr. 18, 2011 (DE) 10 2011 007 588.7

(51) Int. Cl. H04L 29/06

(52) U.S. Cl. CPC H04L 63/0227; H04L 63/0823
USPC 726/10; 726/13

(57) ABSTRACT

A method for control communication between coupled train components, wherein mechanical and electrical couplings as well as devices for exchanging data are present. When a first train component is coupled to at least one further train component, the at least one further train component is identified, and filtering for a permissible data communication is performed as a function of the identification in that only selected data traffic is permitted. Furthermore, a device for control communication between coupled train components is described, wherein the train buses thereof are connected via an electrical coupling, and the data communication to the respective other train component is conducted via at least one gateway with at least one Ethernet interface as well as via at least one interface for connection of each component network. As a result, the data communication of a filter policy/rule is permitted or blocked.

The invention relates to the coupling of train components, wherein in addition to electrical and mechanical coupling, train component buses are also coupled with the result that data exchange can take place. The coupling of a plurality of train components gives rise to the composition of a train.

Train components or cars, in particular rail vehicles, are regularly coupled and disconnected again in the travel mode. In this way a train operator can flexibly compose a train or block train comprising a plurality of train components or trains, wherein said train or block train can be adapted to the intensity of use of the route sections being traveled on. In this context there is the possibility of a block train being composed of cars or train components from different rail operators and different manufacturers.

In addition to the mechanical coupling, compressed air lines for corresponding brakes are also coupled or the power supply lines of the train components are coupled electrically. During the coupling, control buses of the trains can also be connected directly to one another, with the result that the data, for example control messages for lighting, brakes, the drive or proceed signal indication, can be exchanged. In this context, to a certain extent Ethernet-based and IP-based rail vehicle control buses can be coupled to one another. It is, for example, also possible to connect a vehicle control network or an operator network for video monitoring or for the passenger information between coupled train components.

The so-called train bus is already customary today for transmitting data between train components.

The electrical connection between two train components can, in principle, also be produced by means of a plugged-in cable. Under certain circumstances, this connection also connects the train bus of the coupled train components. For example a plug according to a specific standard (UIC 568) can be used for this purpose.

Furthermore it is known that IP communication is used in trains. The problems of addressing occur particularly when coupling trains. The coupling of a train bus to a vehicle bus is implemented by means of a network coupler/gateway or an interface. During what is referred to as a train inauguration process, all the vehicles subsequently know the train topology. This contains the type and the version of other vehicles and the respective number thereof. The numbers of the coupled vehicles are assigned during a coupling process in such a way that the vehicles are completely numbered consecutively.

Furthermore, the use of a firewall when coupling one or more internal Ethernet sections of an Ethernet-based network within a rail vehicle is known. The network access to the train bus can be averted in this way.

In order to transmit data, a wireless coupling by means of optical transmission or by means of radio transmission is also conceivable.

A train component may contain, for example, a plurality of networks or buses, for example a passenger network, a vehicle control network, an operator network, a train protection network or the like. These can be connected between coupled train components, directly or via a train bus.

Furthermore, automatic couplings such as Scharfenberg couplings, in which electrical connections are also produced automatically, are also known. An electro-contacting coupling is integrated into such a mechanical coupling. As a result, electrical connections can be produced between the coupled train components. The use of a firewall is customary for network safety and safe data communication. Said firewall restricts access to the network at a network boundary, on the basis of a selection of the permissible data communication.

Various solutions are known for protecting the access to a network. Generally, a subscriber must prove his authentication before the network access is released. The authentication is carried out, for example, by using a password or a cryptographic key.

Furthermore it is known to use a network access controller/NAC/Network Access Control, wherein the configuration of the connecting device is checked. In this context, it is detected, for example, whether a current virus scanner is installed or whether so-called patches are installed. Only when the settings required of the configuration are satisfied is access granted by means of the access switch. If access is not granted, the subscriber can be rejected or restricted access to an uncritical network can be obtained.

US 2006/0180709 discloses, for example, a method and a system for IP train inauguration. Train inauguration is carried out in an IP-based train control network. In this context, the train topology, in particular that of a power unit, is determined.

The IP address implementation is configured as a function thereof.

Furthermore, a car in the train is detected by using a recognition protocol. The network and the configuration information are transmitted to other units in the train.

The invention is based on the object of preventing a control function of a train component being put at risk during coupling to a further train component.

This object is achieved by means of the corresponding feature combination of the independently formulated patent claims.

The invention is based on the realization that the safety of control functions can be optimized when coupling train components or individual cars to form trains or when coupling entire trains to form a train or block train such as, for example, in the case of the ICE/Inter-City Express. This relates not only to the actual operating safety/safety but also to the operating protection/security for a protected operating sequence.

According to the invention, when a first train component is coupled to a further train component, this additional train component is identified. As a result, by way of example, the manufacturer is identified as are the model, the version, the serial number or the operator. Depending on said identification, the permissible data communication which can occur via a control network of the first train component with a control network of the coupled further train component is filtered. The control network of a train component is, for example, the train control system, a vehicle controller, an operator function such as a passenger information system or the like.

The filtering therefore defines component networks which are each coupled and the data communication which is respectively permissible between these network components occurs via them.

It is therefore possible, for example, for a data communication to be made possible between coupled sections of a train network, for example an Ethernet Train Bus/ETB, while, on the other hand, operator networks or vehicle control networks are not coupled or can only be coupled understood in a restricted way, i.e. filtered. Filtering is understood here to be the evaluation of management data such as header and/or useful data of a control data packet. It is checked whether this is even permissible and/or whether values relating to the local operational data are plausible.

The filtering relates to data messages such as, for example, control instructions, status messages, measured values etc. Overall, a plurality of functions corresponding to a component network can usually be controlled here. For example the air-conditioning, the lighting, the door function, the control of the brakes and drive can be controlled by means of the train control system. By means of a train control system it is possible, for example, to control an automatic train safety function. A passenger information system ensures necessary and convenient supply of information. So-called operator functions can manage energy consumption measurements, and can control passenger metering or video monitoring.

A vehicle network which is provided for a train which is composed of train components is composed internally of a plurality of component networks such as, for example, a train control system, passenger network and operator network. These component networks can be coupled individually between train components. Filtering can also relate to the coupling of these component networks to one another, i.e. a coupling which extends over all the train components can be permitted or blocked. As a result, as a function of the filtering, data communication is permitted or blocked or even conducted on a so-called proxy server. This server which counts as a network component performs in a representative fashion in a network the role of an intermediary, with the result that where possible a connection comes about between communication partners even if the addresses thereof or the protocols used are incompatible with one another.

A rule/policy for filtering during data communication on a train can either be permanently predefined or can be configurable or can even be fed in by a server. When further train components are coupled on, the train network is therefore very flexible when filtering in the case of newly coupled on train components and their separate component networks.

Since most rail vehicles, i.e. more or less any train component, have a separate data bus, coupling to further train components will, as a rule, also mean coupling the data buses of the individual train components. For data communication it is therefore expedient to use at least one network coupler/gateway GW between the train bus and the individual component networks of a train component. As a result, the data communication occurs in accordance with a fixed or configurable filter rule/policy and at the network coupler GW the data communication is categorized as permissible or blocked.

It is advantageous to equip the network coupler/gateway GW with at least one Ethernet interface and with, in each case, an interface for each component network.

If a train component is coupled on both sides to further train components it is advantageous to equip the network coupler with at least two Ethernet interfaces. An Ethernet interface is understood to be a technology which specifies software, for example protocols and hardware, for example distributors or network cards for cable-bound data networks. Originally, these local data networks were conceived for data exchange in the form of data packets between the devices connected in a local network (LAN).

As a rule, a functionality can largely be maintained between the train components, but depending on a filter rule/policy a previous check is carried out to determine whether one or more train components are trustworthy.

It can be particularly advantageous to identify not only the further train components which are coupled directly to the train component but also relatively remote train components. This requires special addressing of the data communication. Otherwise, the procedure for the identification, authentication or communication with or between component networks of various train components is regulated in the same way.

Data transmission can advantageously be carried out between individual train components by means of radio transmission.

In the text which follows, exemplary embodiments which do not restrict the invention are described on the basis of schematic figures, of which, in particular:

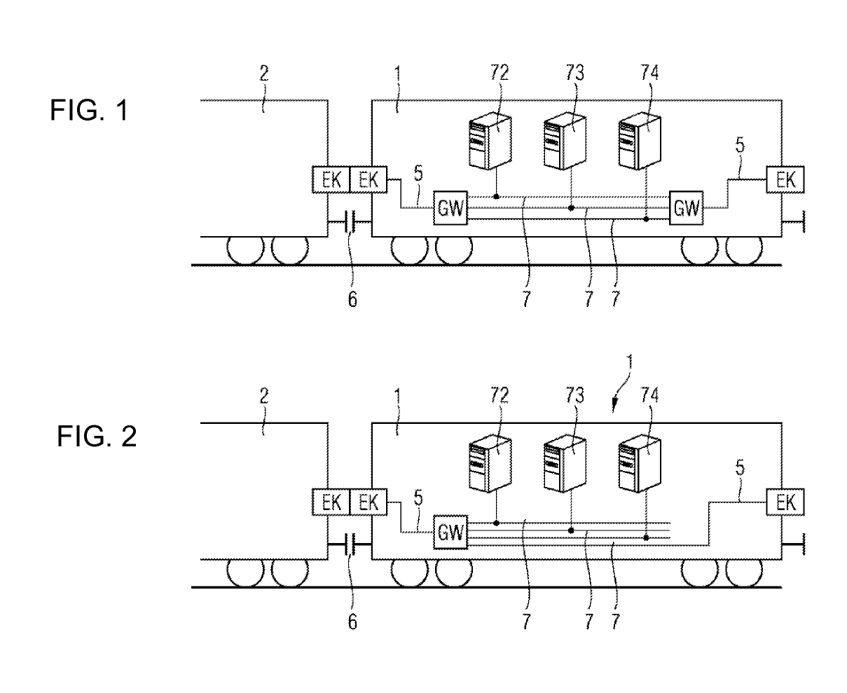

FIG. 1 shows the coupling of two train components, which are rail bound, with a network coupler/Gateway GW which is embodied in a double fashion since in each case electrical coupling EK is to be connected to the component networks 7 via, in each case, one network coupler,

FIG. 2 shows an illustration according to FIG. 1 with the variation that only one network coupler/Gateway GW is provided, which network coupler/Gateway GW is simultaneously connected to the electrical couplings EK,

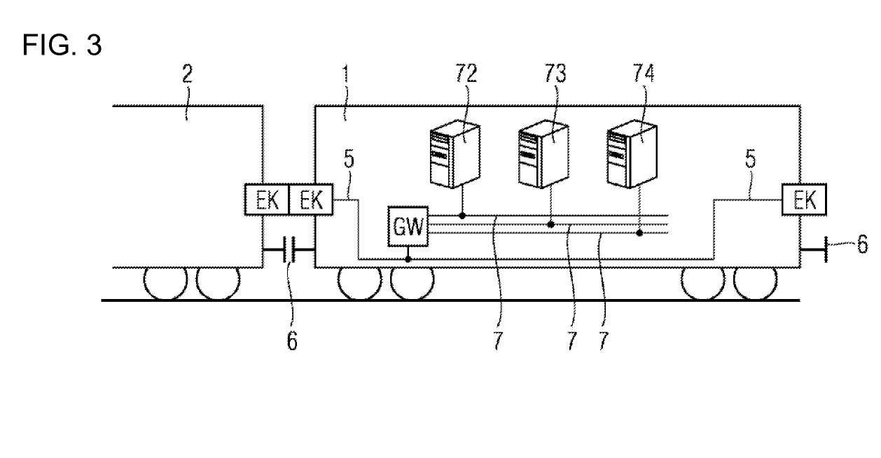

FIG. 3 shows a further variant in which the electrical couplings EK are connected directly on both sides of the first train component 1, and the access to a component network 7 of the first train component 1 takes place via a single network coupler/gateway GW,

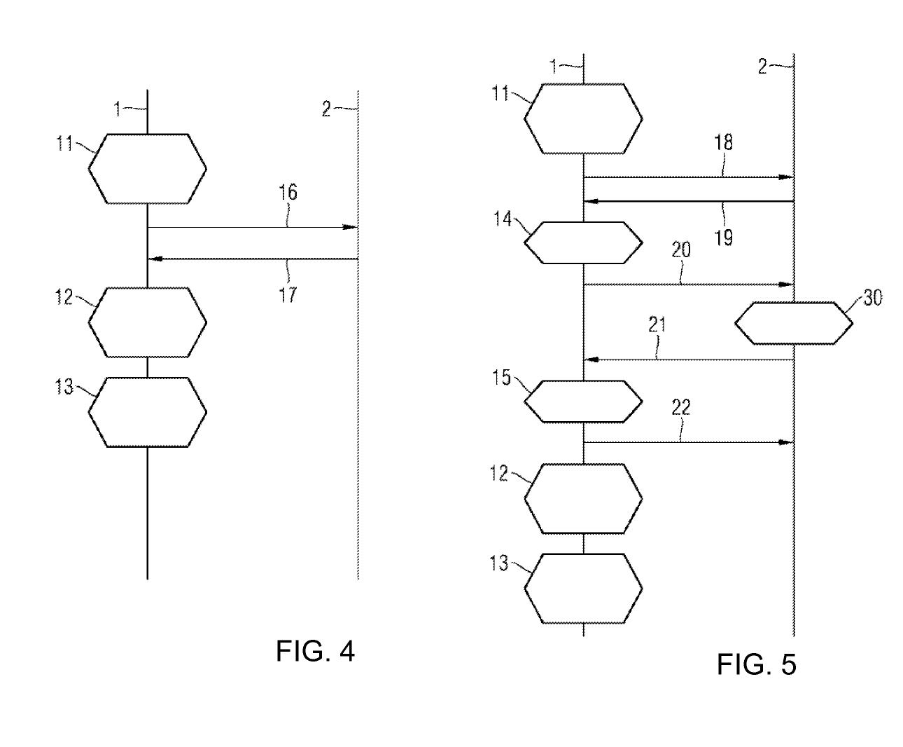

FIG. 4 shows the basic sequence of the identification and the filtering dependent thereon, according to a filter rule, and

FIG. 5 shows a variant in which the further coupled train component 2 is identified by means of a challenge/response authentication process using a digital certificate.

The coupling of component networks 72, 73, 74 can be implemented via separate physical lines. The component networks can, however, also be coupled via a common line by tunneling the data. This is done, for example, by means of VLAN, L2TP. In each case a data packet, a so-called frame, is provided, during the transmission between the two train components, with a mark which permits the receiver to make an assignment to the respective component network.

It is therefore possible, for example in a configuration of the filter rules, for the operator network of a first train component 1 to be connected to the operator network of the further, coupled train component 2, i.e. data packets are passed on between the coupled operator networks. However, in this exemplary configuration it is not possible to respectively connect the passenger network or the train control network, i.e. between the coupled train components, data packets or frames are not passed on between the passenger networks of the coupled train components or between the train control networks of the coupled train components in accordance with the filter rules. It is also possible, for example, for the operator network to be connected only if the coupled train components are associated with the same operator. On the other hand, the train control system/train control network can also be implemented between train components which are assigned to different operators.

The filtering can take place logically in that the data packets which are not permissible in accordance with the filter rules are rejected, i.e. they are not passed on between the coupled train components.

The filtering can also be carried out by means of a controllable electrical contact, for example a relay, which connects through an electrical connection between connectable component networks only if it is permissible in accordance with the filter rules, depending on the coupled on train component.

As a rule, only a basic functionality of component networks or an extended functionality, which is available during train coupling, is necessary and present. As a result, there is no risk when performing coupling with an unknown or non-trustworthy train component. Nevertheless, more wide ranging functionalities can be used insofar as is possible without risk, for example between coupled train components of the same operator. This is possible as soon as this is permitted in accordance with a defined filter rule/policy.

The filtering of a control communication between rail vehicles which can be coupled is illustrated in different variants on the basis of FIGS. 1 to 3.

FIG. 1 shows two network couplers for filtering data traffic with a coupled further train component 2. During the coupling process, train buses or vehicle buses are coupled to one another via an electrical coupling EK. The data communication with the further train component 2 is conducted via a train coupling gateway GW. The data communication is either permitted or blocked in accordance with a filter rule/policy.

In FIG. 1, three component networks 7; 72, 73, 74 are provided within the first train component 1, said component networks 7; 72, 73, 74 being used to implement different component functions. It is therefore possible to operate the train control system 72 and the passenger information 73 or even the video monitoring system 74 individually. In each case, for example a component is illustrated which is connected to the respective component network. However, in general a plurality of components are present: the control devices for subsystems of a train control system, which are controlled and monitored by a train control server for controlling a plurality of displays of a passenger information system which are controlled by a PIS server; and a CCTV server which receives and stores images of a plurality of CCTV cameras.

FIG. 2 shows a variant to the illustration according to FIG. 1, in which only a single network coupler/gateway GW is provided. This network coupler is connected simultaneously to the electrical coupling EK on both sides of the train. In this case, in FIG. 2 there is no direct connection of the train buses 5 which start from the two train couplings EK.

FIG. 3 shows a further variant in which the electrical couplings EK are connected to one another directly via the train bus 5 on both sides of the train component. The network coupler GW is intermediately connected between the train bus 5 and one or more component networks 7. In this context, the network coupler/gateway cannot differentiate whether the data communication takes place via the left-hand or the right-hand electrical coupling EK. It is possible here for identification to take place of both the left-hand and of the right-hand coupled train component. As a function of this a filter rule/policy is determined by the gateway.

In one variant, the directly coupled train component is identified. However, in a further variant more remote train components are also identified. This means that those train components which are coupled indirectly via a directly coupled train component can also be identified. The filter rule/policy which is applied here can then be determined or adapted as a function of these further identified train components.

The identification of the further coupled train component 2 can be protected, in particular, cryptographically by authentication. As a result, the further coupled train component 2 can be reliably identified. This can be done, for example, by means of a digital certificate, for example according to X.509, wherein the digital certificate is assigned to the further coupled train component 2. The digital certificate of the coupled train component 2 is checked by the first train component 1 during the authentication of the further train component 2. The certificate contains the public key of the coupled further train component 2 as well as further attributes assigned to the further train component 2 such as, for example, manufacturer, model, serial number, operator, train number and so on. A chronological validity information item can also be included. In one variant, the further coupled train component 2 has a static train component identification and a separate operator train identification, wherein the first is manufacturer-related and the second is embodied in an operator-related fashion, and the latter assigns the train component to a specific use for an operator. It is then possible to determine, for example, whether two coupled train components are actually assigned to the same train number.

In a further variant, information as to which further train components 2 are coupled or are to be coupled is stored on a first train component 1. In a further variant, this information is interrogated by an external server during the coupling by means of a data communication, for example by means of radio, such as UMTS, WLAN or WIMAX. As a result it is possible to check and take into account during the filtering whether the coupling on of a further train component 2 is also actually provided in accordance with the operational planning.

If an X.509 certificate is used to authenticate a further train component 2, said certificate is basically structured as follows:

Digital certificate having:

Certificated ID: Serial number

Allocated to: Name

User: Name

Valid from: Time

Valid until: Time

Public Key

Features

Feature A

Feature B

Signature (digital signature)

According to the prior art, a feature can be used to encode further information about the certificate or the subject for which the certificate is issued. For a feature, a specific name or an IP address can be included in the coding. This specifies the e-mail address or server address of an SSL-TLS server for which the certificate is to be considered as valid. This information relates to the subject, i.e. to the person who is authenticated by this certificate.

It is advantageously possible for a digital certificate or even a digital train certificate to be used to include train identification in the coding. As a result, such a certificate can be used to authenticate a train component with respect to a coupled train component. An authentication, for example for manufacturer, model, serial number etc. or operator information such as train number of the operator in accordance with the timetable of the route or the home station of the train component can be encoded. It is also possible to provide separate certificates for the train component information and the operator information assigned thereto. This information may be encoded, for example, in a field “issued to” or in an attribute field/feature field.

With respect to the train component authentication it is to be noted that the identification of a coupled train component can take place by means of different standards and protocols. It is possible to use for this purpose, for example, an SSL, TLS, IKE or EAP protocol.

FIG. 4 shows the basic design in the case of a coupled train component 2 which is identified and as a function thereof is activated, i.e. permitted, to perform data communication in accordance with a filter rule/filter policy. The data communication can also be blocked during the filtering as a function of the filter rule. A filter rule is valid as long as the train remains coupled. During the decoupling or re-coupling another filter rule is determined and activated in turn.

The individual steps according to FIG. 4 signify:
1 First train component
2 Further train component
11 Determination of the train coupling
12 Determination of the train traffic control rule/policy
13 Activation of the train traffic control rule/policy
16 Requesting of the train ID
17 Train ID.

FIG. 5 shows a variant in which the coupled train component 2 is identified by means of a so-called challenge/response authentication process using a digital certificate. It is illustrated by way of example but only the further coupled train component is firstly identified. In general, the further coupled train component can also carry out the corresponding steps, i.e. the train component also identifies the further train component 2 which is coupled thereto, and a corresponding filter rule is selected and activated. In this context, in particular mutual authentication of the two further train components can take place.

If data is exchanged with a coupled train component in a transmitting or receiving fashion, it is checked whether this data communication corresponds to the defined filter rule. If “YES” (“allow”), the data communication is permissible and can take place. If “NO” (“deny”) this data communication is blocked.

The filtering of the data traffic can take into account, in particular, the following criteria:
protocol (for example ARP, IP, ICMP, DHCP, UDP, TCP)
sender/address (for example MAC address, IP address)
transmitting address (for example MAC address, IP address)
post numbers (for example UDP port number, TCP port number, ICMP service)
URL/URI, for example of a web service,
data contents (for example content of a control instruction, measured value). It is possible that, in particular, the data are validated as a function of the vehicle identification and/or of local intrinsic data, such as, for example, speed or temperature;
a vehicle periodically emits vehicle properties such as length and weight, for example in the case of WTB. This data can be validated as a function of the vehicle identification. The reference data can be included, for example, in the digital certificate of the vehicle or it can be determined from a database by means of the vehicle identification contained therein. Corresponding WTB messages are passed on only if this data is consistent with extended data.
dynamic operating safety/safety-relevant data such as, for example, “doors closed” is passed on only if the vehicle's own doors are also closed, i.e. the filtering takes place as a function of the actual state of the train component. Only messages which are consistent in terms of content with the local and therefore trustworthy control data are passed on.

In FIGS. 4 and 5, the sequence of a train identification or train authentication is illustrated by way of example.

In FIG. 4, the train identification number is interrogated only once and is transmitted back in a subsequent step.

According to FIG. 5, a digital certificate is interrogated which is transmitted back in the form of the certificate 19 CERT in the response information. This certificate CERT is examined for its validity or authenticity, i.e. it is checked whether it is a valid certificate issued by a trustworthy certification authority.

Subsequent to this, for example a challenge/response authentication is carried out in order to authenticate the further coupled train component 2. As a function of which further train component 2 is coupled on, filter rules which define the control data which it is permitted to transmit with the further coupled train component are selected and activated. Control data is transmitted to or from the further coupled train component insofar as it is permissible in accordance with the selected and activated filter rules.

The individual steps corresponding to FIG. 5 mean:
1 First train component
2 Further train component
11 Determination of the train coupling
12 Determination of the train traffic control rule/policy
13 Activation of the train traffic control rule/policy
14 Verification of the certificate
15 Verification of the response
18 Certificate request
19 Certificate: CERT
20 Request for proof of authentication
21 Authentication response: R
22 O.K.
30 Calculation of the response

1-17. (canceled)

18. A method for control communication between coupled train components, wherein the train components include mechanical couplings, electrical couplings, and devices for exchanging data, the method comprising the following steps:
upon coupling a first train component to at least one further train component, identifying the at least one further train component; and
filtering for a permissible data communication as a function of an identification obtained in the identifying step by permitting only selected data traffic.

19. The method according to claim 18, which further comprises performing filtering for a permissible data communication in that only selected component networks are coupled in all the train components.

20. The method according to claim 18, which comprises permitting or blocking a data communication as a function of the filtering or conducting data communication on a proxy server.

21. The method according to claim 18, wherein the filtering respectively relates to an evaluation of data of the train components, with checking as to whether data of a further train component are permitted and/or plausible and/or compatible with the data of the first train component.

22. The method according to claim 18, which comprises implementing the data communication as packet-based data communication.

23. The method according to claim 18, wherein the filtering during coupling to a first train component follows a filter rule/policy.

24. The method according to claim 23, wherein the filter rule/policy for filtering during coupling to a first train component is permanently predefined, is configured, or is received by a server.

25. The method according to claim 18, wherein filtering relates to data messages for at least one of the following functions or component networks:
train control system selected from the group consisting of air-conditioning control, lighting;
door control, brake control, and drive control;
train protection;
passenger information; and
operator functions selected from the group consisting of energy consumption measurement, passenger meters, and video monitoring of the passenger compartment.

26. The method according to claim 18, which comprises conducting the data communication via at least one network coupler/gateway configured to permit or block the data communication in accordance with a filter rule/policy.

27. The method according to claim 18, which comprises identifying further train components which are coupled directly to the first train component and also further remote train components in order to set up a filter rule/policy for a train control system.

28. The method according to claim 18, which comprises cryptographically authenticating the further train component.

29. The method according to claim 28, which comprises authenticating the further train component by way of a digital certificate which is checked by the first train component during authentication.

30. The method according to claim 29, which comprises, for authenticating a coupled further train component, implementing a challenge/response authentication process with:
symmetrical authentication of the further train component using a secret key or password; and
asymmetrical authentication using a public key and a private key of the further train component; and
asymmetrical authentication, wherein the public key of the further train component is confirmed by way of a digital certificate.

31. The method according to claim 18, which comprises interrogating a data communication externally via at least one radio network during the coupling.

32. The method according to claim 18, which comprises retaining a determined filter rule/policy, which is activated, to remain valid for as long as the train is coupled, and newly determining the filter rule/policy upon uncoupling or recoupling.

33. The method according to claim 18, wherein a first train component is coupled on both sides via the electrical couplings, and the access to a component network of the first train component takes place via a network coupler, and a filter rule/policy is determined by way of the network coupler.

34. A device for control communication between coupled train components, comprising:
an electrical coupling interconnecting train buses of the train components;
at least one network coupler for enabling data communication of a first train component to a respective further train component, said at least one network coupler having at least one Ethernet interface; and
at least one interface for connecting each component network, to thereby selectively permit or block the data communication in accordance with a given filter rule/policy.

35. The device according to claim 34, wherein in a first train component a train bus which starts from an electrical coupling is directly connected to the respective other train bus, and a single network coupler/gateway is present for access to a component network.
